(19) United States
(12) Patent Application Publication
(10) Pub. No.: US 2009/0164657 A1
(43) Pub. Date: Jun. 25, 2009

(54) APPLICATION AWARE RATE CONTROL

(75) Inventors: Jin Li, Sammamish, WA (US); Philip A. Chou, Bellevue, WA (US); Minghua Chen, Hong Kong (CN)

Correspondence Address: MICROSOFT CORPORATION;C/O LYON & HARR, LLP, 300 ESPLANADE DRIVE, SUITE 800, OXNARD, CA, 93036, US

(73) Assignee: MICROSOFT CORPORATION, Redmond, WA (US)

(21) Appl. No.: 11/961,900

(22) Filed: Dec. 20, 2007

(51) Int. Cl. G06F 15/173

(52) U.S. Cl. 709/233

(57) ABSTRACT

A “communications rate controller” provides various techniques for maximizing a quality of real-time communications (RTC) (including audio and/or video broadcasts and conferencing) over multi-hop networks such as, for example, the Internet. Endpoints in such networks generally communicate via a segmented path that extends through one or more routers between each endpoint. Maximization of conferencing quality is generally accomplished by providing in-session bandwidth estimation across segments of the network path between endpoints (i.e., communication/conference participants) in combination with a robust non-oscillating dynamic rate control strategy for maximizing usage of available bandwidth between RTC endpoints. Further, the dynamic rate control techniques provided by the communications rate controller are designed to prevent degradation in end-to-end delay, jitter, and packet loss characteristics of the RTC.

### BACKGROUND

1. Technical Field

A “communications rate controller” is related to in-session bandwidth estimation and rate control, and in particular, to various techniques for accurately gauging available bandwidth between endpoints in a network communications session, such as, for example, audio and/or video conferencing, remote desktop sessions, and for dynamically adjusting communications quality to maximally utilize available bandwidth between the endpoints.

2. Related Art

Bandwidth estimation between a sender and a receiver (i.e., “endpoints”) across a network is typically performed out-of-session. In other words, available bandwidth of the network pipe or path between the endpoints is probed once, typically at the beginning of the communications session, with the measured bandwidth then being used for subsequent communication between the endpoints. There are several techniques for performing out-of-session bandwidth estimation.

For example, one class of bandwidth estimation techniques use Probe Rate Model (PRM) based schemes for bandwidth estimation. In PRM based approaches, the sender and the receiver generally apply iterative probing by transmitting data packets at different probing rates, to search for the available bandwidth of the path between the sender and the receiver. The sender and the receiver determine whether a probing rate exceeds the available bandwidth by examining the one way delay between the sender and the receiver. Once a particular probing rate exceeds the available bandwidth, the sender then uses that rate information for adjusting the probing rate, e.g., by performing a binary rate search, to determine a maximum available bandwidth. Unfortunately, in the case of PRM-based approaches, the iterative probing typically results in a relatively slow bandwidth estimation that is unsuitable for real time communications.

Another class of bandwidth estimation techniques use Probe Gap Model (PGM) based schemes for bandwidth estimation. Typically, in conventional PGM based approaches, the sender sends out a sequence of packets at a rate higher than the available bandwidth of the path. One choice of such probing rates involves the use of a bandwidth capacity of a “tight link” (i.e., the smallest residual bandwidth capacity link) in a multi-hop path (e.g., links forming a path between multiple routers) between the sender and the receiver across the Internet). Note that the term “narrow link” differs from a “tight link” in that the narrow link is the link with the minimum capacity, while the tight link having the link with the minimum residual bandwidth. Assuming the capacity of the tight link is known or can be estimated, the sender and receiver can generate an estimate of the available bandwidth based on sending and receiving gaps of probing packets sent at different data rates. Unfortunately, when there is more than one link between the sender and the receiver, PGM-based approaches often significantly underestimate the available bandwidth when the probing rate is significantly higher than the available bandwidth of the path. Further, knowledge of the tight link bandwidth capacity in a multi-hop path is difficult to obtain or verify in real-world data transmission scenarios.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In general, a “communications rate controller” provides various techniques for maximizing a quality of real-time communications (RTC) (including audio and/or video broadcasts and conferencing, terminal services, etc.) over networks such as, for example, the Internet. “Endpoints” in such networks generally communicate via a segmented or “multi-hop” path that extends through one or more routers between each endpoint. Typically, each “endpoint” represents either a communications device or portal (e.g., computers, PDA's, telephones, etc.) that is either (or both) transmitting a communication to another endpoint, or receiving a communication from another endpoint across the multi-hop network.

More specifically, the communications rate controller provides various techniques for maximizing conferencing quality by providing in-session bandwidth estimation across segments of the network path between endpoints (i.e., communication/conference participants). This bandwidth estimation is used in combination with a robust non-oscillating dynamic rate control strategy for maximizing usage of available bandwidth between RTC endpoints. In various embodiments, this in-session bandwidth estimation continues periodically throughout a particular communications session such that the overall communications rate may change dynamically during the session, depending upon changes in available bandwidth across one or more segments of the network.

In various embodiments, available bandwidth estimation is based on queuing delay evaluations of “probe packets” periodically transmitted along the network path between endpoints during a communications session between those endpoints are used to dynamically identify available bandwidth capacity across an entire path in view of an allowable delay threshold. In various embodiments involving voice-based communications sessions, where voice quality is an important concern, the delay threshold is set based on an allowable delay for voice packets across the network that will ensure a desired voice quality level in terms of communications issues such as packet loss and jitter. However, other criteria are used in related embodiments to set the allowable delay threshold. Available bandwidth capacity estimations are then used to provide dynamic control of the communications rate between the endpoints in order to maximize RTC quality between the endpoints.

In view of the above summary, it is clear that the communications rate controller described herein provides a variety of unique techniques for providing application aware rate control for real-time communications scenarios. In addition to the just described benefits, other advantages of the communications rate controller will become apparent from the detailed description that follows hereinafter when taken in conjunction with the accompanying drawing figures.

### DESCRIPTION OF THE DRAWINGS

The specific features, aspects, and advantages of the present invention will become better understood with regard to the following description, appended claims, and accompanying drawings where:

FIG. 1 provides an example of two endpoints communicating via a multi-hop path through a number of routers across a network such as the Internet.

FIG. 2 provides an exemplary architectural flow diagram that illustrates program modules for implementing various embodiments of a communications rate controller, as described herein.

FIG. 3 illustrates a prior art example of one-way delay as a function of probing rate for conventional Probe Rate Model (PRM)-based bandwidth allocations techniques.

FIG. 4 illustrates a prior art example for estimating available bandwidth in conventional Probe Gap Model (PGM)-based bandwidth allocations techniques.

FIG. 5 illustrates a general system flow diagram that illustrates exemplary methods for implementing various embodiments of the communications rate controller, as described herein.

FIG. 6 is a general system diagram depicting a general-purpose computing device constituting an exemplary system for implementing various embodiments of the communications rate controller, as described herein.

FIG. 7 is a general system diagram depicting a general computing device having simplified computing and I/O capabilities for use in implementing various embodiments of the communications rate controller, as described herein.

### DETAILED DESCRIPTION OF THE PREFERRED EMBODIMENTS

In the following description of the preferred embodiments of the present invention, reference is made to the accompanying drawings, which form a part hereof, and in which is shown by way of illustration specific embodiments in which the invention may be practiced. It is understood that other embodiments may be utilized and structural changes may be made without departing from the scope of the present invention.

### 1.0 Introduction

In general, a “communications rate controller,” as described herein, provides various techniques for enabling application aware rate control for real-time communications (RTC) scenarios over multi-hop networks such as, for example, the Internet. Examples of RTC scenarios include, for example, audio and/or video broadcasts, conferencing between endpoints, and terminal service sessions. The various rate control techniques enabled by the communications rate controller are used to maximize RTC quality by dynamically varying sending bandwidth from a sending endpoint to a receiving endpoint across the network based on real time estimates of available sending bandwidth from the sender to the receiver.

Endpoints in such networks generally communicate via a segmented or “multi-hop” path that extends through one or more routers between each endpoint. Typically, each “endpoint” represents either a communications device or portal (e.g., computers, PDA's, telephones, etc.) that is either (or both) transmitting a communication to another endpoint, or receiving a communication from another endpoint across the multi-hop network.

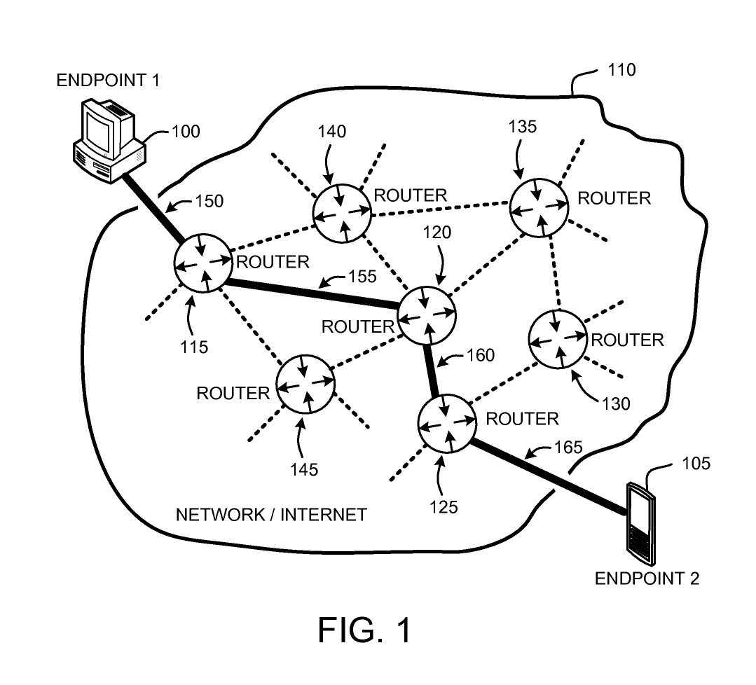

An example of two endpoints in either one-way or two-way communication across a multi-hop network is illustrated in FIG. 1. In particular, FIG. 1 shows a communications path from a first endpoint 100 to a second endpoint 105. This communications path extends across several network routers, including routers 115, 120, and 125, and having path segments 150, 155, 160 and 165 between those routers. Note that a return communications path from the second endpoint 105 to the first endpoint 100 does not necessarily follow the same path segments as from the first endpoint to the second endpoint. For example, the communications path from the second endpoint 105 to the first endpoint 100 could include routers 125, 130, 135, 140, and 150, along with the corresponding path segments.

Clearly, many different paths between endpoints across the network are possible depending upon network topology. However, actual path selection is not a specific consideration of the communications rate controller, since it is assumed that the network will automatically route traffic between the endpoints based on the network topology in combination with other factors including network coding rules. Further, the path between any two endpoints may change during a particular communications session depending upon variables such as network traffic and router status. However, since available bandwidth between endpoints is evaluated periodically, bandwidth changes resulting from changes to the network path are automatically handled by the communications rate controller when setting the communications rate between endpoints.

Note also, that given the nature of typical multi-hop networks such as the Internet, it is possible for two endpoints to communicate with each other by partially different paths that diverge at one or more routers. However, this particular point is not a significant issue, as the transmission bandwidth from any one endpoint to any other endpoint is evaluated separately from any available return bandwidth. In other words, a maximum available transmission bandwidth from any endpoint to any other endpoint is determined independently using the various dynamic bandwidth estimation techniques described herein. The communications rate controller then dynamically controls the sending communications bandwidth based on the maximum available transmission bandwidth.

### 1.1 System Overview

As noted above, the communications rate controller provides various techniques for enabling application aware rate control for real-time communications scenarios.

More specifically, as described in greater detail in Section 2, the communications rate controller provides various techniques for maximizing conferencing quality by providing in-session bandwidth estimation across segments of the network path between endpoints (i.e., communication/conference participants) in combination with a robust non-oscillating dynamic rate control strategy for maximizing usage of available bandwidth between RTC endpoints. In additional embodiments, the dynamic rate control techniques provided by the communications rate controller are designed to prevent degradation in end-to-end delay, jitter, and packet loss characteristics of the RTC. Note however, that in various embodiments, packet loss is not considered when performing the packet delay calculations that are further described below.

As described in greater detail in the following sections, statistical packet queuing delay evaluations of “probe packets” periodically transmitted along the network path between endpoints are used to dynamically estimate available bandwidth (from the sending endpoint to the receiving endpoint) in view of a “delay threshold.” As described in further detail in Section 2, the “probe packets” can be specially designed packets, including Internet Control Message Protocol (ICMP) packets, or can be packets from the communications stream itself.

In voice-based communications sessions, where voice quality is an important concern, the delay threshold can be set based on an allowable delay for voice packets across the network that will ensure a desired voice quality level in terms of communications issues such as packet loss and jitter. Available bandwidth capacity estimations are then used to provide dynamic control of the communications rate between the endpoints in order to maximize RTC quality between the endpoints. Note that this delay threshold actually represents an additional delay across the communications path that is acceptable. In particular, the delay between two endpoints is determined by the route, and may change from time to time if the route changes. Therefore, the delay threshold actually represents an additional incremental delay which is used as a trigger signal by the communications rate controller to control the sending rate.

In related embodiments, different criteria are used for setting the allowable delay threshold depending upon the particular communications application. For example, assuming a PRM model, the communications rate controller can determine whether a route is congested or not. When a route is not congested, the communications rate controller collects relative-one-way-delay (ROWD) samples from the received packets. The communications rate controller then learns a mean and variance of the ROWD from the collected samples. The delay threshold is then sent as a combined function of the mean and variance. Clearly, any desired criteria for setting an allowable delay threshold may be used depending upon the particular communications application and the desired quality of the communications.

In various embodiments, this in-session estimation of available bandwidth continues periodically throughout a particular communications session such that the communications rate may change dynamically during the session, depending upon changes in available bandwidth across the network, as constrained by a tight link along the network path between endpoints.

Note that the available bandwidth between any two endpoints may not be the same each direction, depending upon factors such as, for example, other network traffic utilizing particular routers between the two points. Further, it should also be noted that communications can be two-way (e.g., from endpoint 1 to endpoint 2, and from endpoint 2 to endpoint 1), or that communications can be one way (e.g., from endpoint 1 to endpoint 2). Consequently, the communications rate between any two endpoints can vary dynamically since there is no requirement for the sending rate of two communicating endpoints to be the same. However, in one embodiment, the communications rate between two endpoints is limited to the lower of the sending rate of each of the two endpoints such that each endpoint will receive the same quality communications transmission from the other endpoint.

Further, in other embodiments, the communications rate controller is used to provide rate control for layered or scalable rate communications sessions. In general, conventional scalable coding allows for a layered representation of a coded bitstream. A “base layer” then provides the minimum acceptable quality of a decoded communications stream, while one or more additional “enhancement layers” serve to improve the quality of a decoded communications stream. Each of the layers is represented by a separate bitstream. Therefore, in the case of scalable coding, the communications rate controller gives priority to transmission of the base layer, then dynamically adds or removes enhancement layers during the communications session to maximize use of available bandwidth based on the periodic in-session bandwidth estimation between the endpoints.

### 1.2 System Architectural Overview

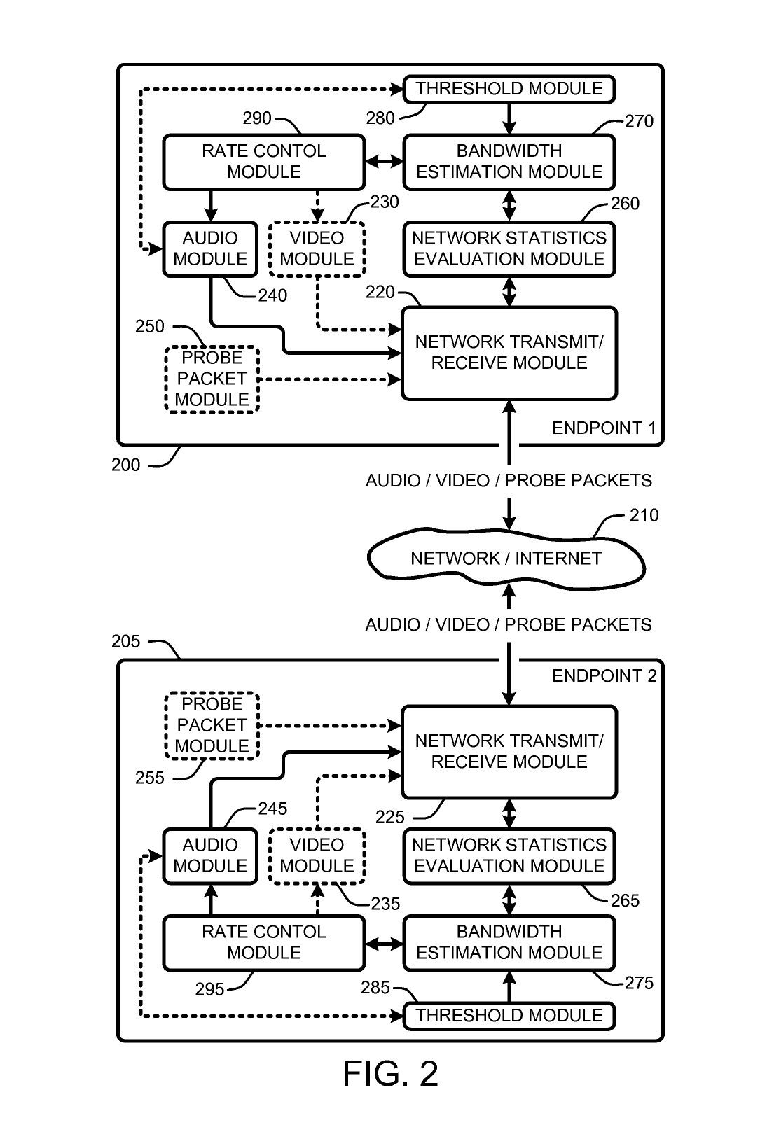

The processes summarized above are illustrated by the general system diagram of FIG. 2. In particular, the system diagram of FIG. 2 illustrates the interrelationships between program modules for implementing various embodiments of the communications rate controller, as described herein. Furthermore, while the system diagram of FIG. 2 illustrates various embodiments of the communications rate controller, FIG. 2 is not intended to provide an exhaustive or complete illustration of every possible embodiment of the communications rate controller as described throughout this document.

In addition, it should be noted that any boxes and interconnections between boxes that are represented by broken or dashed lines in FIG. 2 represent alternate embodiments of the communications rate controller described herein, and that any or all of these alternate embodiments, as described below, may be used in combination with other alternate embodiments that are described throughout this document.

In general, as illustrated by FIG. 2, any endpoint (200 and 205) can act as either or both a sending endpoint or a receiving endpoint relative to the other endpoint. However, for purposes of explanation, the following discussion will generally refer to endpoint 200 as a “sending endpoint” and to endpoint 205 as a “receiving endpoint.” Therefore, the following discussion will address estimation of the available bandwidth from the sending endpoint 200 to the receiving endpoint 205. However, in actual operation, separate simultaneous bandwidth estimations from each sending endpoint (any of 200 and 205) to any corresponding receiving endpoints (any of 200 and 205) will be performed by local instantiations of the communications rate controller operating at each sending endpoint. Further, since each endpoint can be either or both a sending endpoint and a receiving endpoint, available sending bandwidth estimation is performed periodically during a communications session from each sending endpoint (200 and/or 205) to each receiving endpoint (200 and/or 205).

In general, once the available bandwidth has been estimated, that available bandwidth is used to transmit a communications stream from the sending endpoint to the receiving endpoint 205. During any particular communications session, audio packets sent from the sending endpoint 200 are generated by an audio module 230 using conventional audio coding techniques. Similarly, if video is also being used, video packets are generated by a video module 240 using conventional video coding techniques. However, in contrast to conventional techniques, the actual coding rates for both audio and video data packets are dynamically controlled by a rate control module 290 based on periodic estimations of available bandwidth from the sending endpoint 200 to the receiving endpoint 205. Where both endpoints 200 and 205 are participating in a two-way communications session, estimation of available sending bandwidth is performed separately from each endpoint to the other. Otherwise, in the case where only one of the endpoints 200 is sending and the other endpoint is receiving only, estimation of available sending bandwidth will only be performed for the sending endpoint 200.

As described in further detail in Section 2, available bandwidth estimation begins by sending one or more “probe packets” from the sending endpoint 200 to the receiving endpoint 205. In various embodiments, these probe packets are specially designed data packets. Alternately, packets from the communications stream itself are used as probe packets. In the case where the specially designed probe packets are used, they are provided by a probe packet module 250 that constructs the probe packets and provides then to a network transmit/receive module 220 for transmission across a network 210 to the receiving endpoint 205.

In general, a sending rate of probe packets from the sending endpoint 200 to the receiving endpoint 205 across the network 210 is increased until a “queuing delay” of those probe packets increases above an acceptable delay threshold. The delay threshold is set via a threshold module 280. In one embodiment, the delay threshold is either specified by a user, or automatically computed based on a delay tolerance of audio packets relative to packet loss and jitter control characteristics across the network.

In various embodiments, ICMP packets are used as the probe packets to quickly measure queuing delay. Further, in various embodiments involving voice-based communication sessions, voice activity detection (VAD) is used to trigger more aggressive probing during detected speech silence periods. In particular, in such embodiments, rather the use up the available bandwidth to send probe packets at the cost of actual communications data packets, whenever speech silence is detected, the communications rate controller will increase the sending rate of probe packets to better characterize the current available bandwidth from the sending endpoint 200 to the receiving endpoint 205.

As soon as a network statistics evaluation module 260 observes a queuing delay exceeding the specified delay threshold, then the current sending rate of the probe packets (i.e., a “probing rate”) exceeds the available bandwidth between the sending endpoint 200 and the receiving endpoint 205. The network statistics evaluation module 260 then sends this information to a bandwidth estimation module 270 that estimates the available bandwidth given the current probing rate in view of the delay threshold and the current sending rate. The rate control module 290 then uses this estimated available bandwidth to directly control the communications rate of any audio and video data packets being transmitted from the sending endpoint 200 to the receiving endpoint 205.

The above described processes then continue throughout the duration of the communications session such that the communications rate from the sending endpoint 200 to the receiving endpoint 205 will vary dynamically during the communications session.

Finally, it should be noted that receiving endpoint 205 in FIG. 2 includes program modules (225, 235, 245, 255, 265, 275, 285 and 295) that are similar to those illustrated and described with respect to the sending module 200. As noted above, each endpoint (200 and 205) can act as a sending endpoint, and, as such, each of those endpoints will include the functionality generally described above with respect to the sending endpoint 200.

### 2.0 Operation Overview

The above-described program modules are employed for implementing various embodiments of the communications rate controller. As summarized above, the communications rate controller provides various techniques for providing application aware rate control for RTC applications. The following sections provide a detailed discussion of the operation of various embodiments of the communications rate controller, and of exemplary methods for implementing the program modules described in Section 1 with respect to FIG. 2.

### 2.1 Operational Details of the Communications Rate Controller

In general, the communications rate controller provides various techniques for maximizing conferencing quality by providing in-session bandwidth estimation across segments of the network path between endpoints joined in a RTC session. The following paragraphs detail various embodiments of the communications rate controller, including: an overview of Probe Rate Model (PRM) and Probe Gap Model (PGM) based network path bandwidth probing techniques; exemplary bandwidth utilization scenarios; available bandwidth estimations for RTC; and an operational summary of the communications rate controller.

### 2.2 Overview of PRM- and PGM-Based Probing Techniques

In general, the communications rate controller provides a novel rate control session that draws from both PRM and PGM-based rate control techniques to provide hybrid rate control techniques that provide advantageous real time rate control benefits for RTC applications that are not enabled by either PRM or PGM based techniques alone. Consequently, in order to better describe the functionality of the communications rate controller, PRM and PGM-based techniques are first described in the following sections to provide a baseline that will assist in providing better understanding of the operational specifics of the communications rate controller.

### 2.2.1 PRM-Based Probing Techniques

In PRM based approaches, the sender and the receiver generally apply iterative probing at different probing rates, to search for the available bandwidth of the path between the sender and the receiver. The sender and the receiver then determine whether a probing rate exceeds the available bandwidth by examining the one way delay between the sender and the receiver. The sender then adjusts the probing rate to perform an iterative binary search for the available bandwidth in order to set a communications rate between the sender and the receiver.

In general, the one way delay between the sender and the receiver is denoted as “d”, which is sum of one way propagation delay, denoted as dₚ, and the one way queuing delay along the path from the sender to the receiver, denoted as d_{q}. In other words, the one way delay d is given by Equation (1), where:

d=dₚ+d_{q} Equation (1)

Note that dₚ depends on the characteristics of the path, which is assumed to be constant as long as the path does not change. Further, d_{q} is the sum of queuing delays at each router along the path between the sender and the receiver.

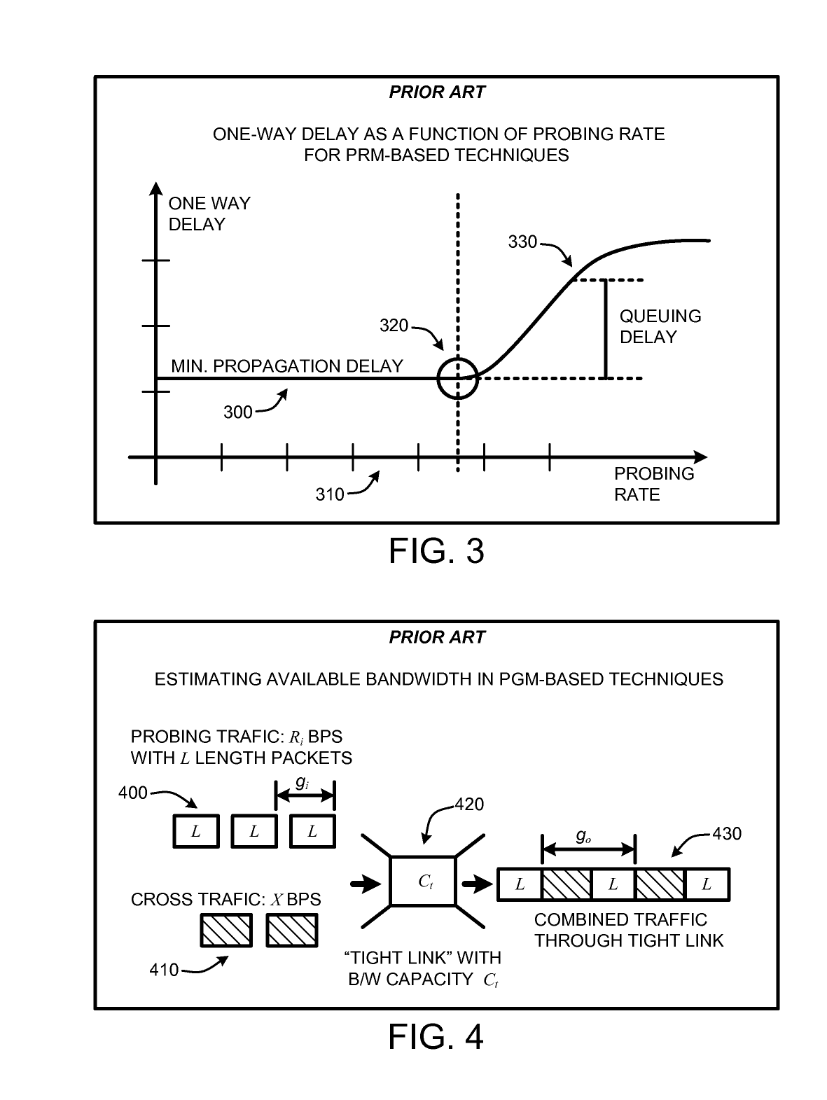

As illustrated by the Prior Art plot shown in FIG. 3, if the probing rate is less than the available bandwidth of the path, then queue at each router along the path between the sender and the receiver should be empty. Therefore, d_{q}=0 and d is constant (corresponding to a minimum propagation delay shown in segment 300 of the plot). On the other hand, if the probing rate 310 exceeds the available bandwidth of the path (beginning at point 320 of the plot), it is well known that d_{q} 320 will first monotonically increase as a consequence of an increasing queue of packets at the tight link (i.e., the smallest bandwidth capacity link or router), as illustrated by segment 330 of the plot. At this point, d_{q} will then stay at a large constant value when the queue is overflowed and packets are dropped. Consequently, in this case, the queuing delay d will first monotonically increase and then keep at a large constant value, as illustrated by FIG. 3.

In particular as illustrated by FIG. 3, when using conventional PRM-based probing techniques, in each probe, the sender sends some number (e.g., 100 or so) of conventional UDP packets (i.e., “User Datagram Protocol” packets) from the sender to the receiver at a certain probing rate 310. Each UDP packet carries a timestamp, recording the departure time of the packet. Upon receiving each UDP packet, the receiver reads the timestamp, compares it to current time, and computes one sample of the (relative) one way delay, also referred to as the minimum propagation delay from the sender to the receiver. In this way, the receiver gets a series of one way delay samples, with that delay information then being returned to the sender. By observing an increasing trend in these one way delays samples the sender/receiver can determine whether the probing rate is higher than the available bandwidth of the path, and vice versa.

One advantage of PRM based approaches is that it is not necessary to make any assumptions regarding the underlying network topology or link capacity. However, one disadvantage of PRM based approaches is that these techniques need to perform iterative probing, resulting in slow estimation times that are often not suitable for RTC applications where available bandwidth may change faster than the PRM based rate estimation times. As a result, PRM based techniques provide sending rates that are either generally below or above the actual available bandwidth, resulting in a degradation of the communications quality that could be provided given more timely and accurate available bandwidth estimations.

### 2.2.2 PGM-Based Probing Techniques

In contrast to PRM-based bandwidth estimation techniques, conventional Probe Gap Model (PGM) based approaches generally involve the sender sending a sequence of packets at a rate higher than the available bandwidth of the path. One choice of such probing rates is the known or assumed capacity of the tight link in the communications path. Assuming that the capacity of the tight link is known or can be estimated, the sender and receiver can generate an estimate of the available bandwidth based on the sending and receiving gaps (i.e., delay times) of the probing packets. The basic idea behind estimating the available bandwidth in conventional PGM based approaches is demonstrated by the Prior Art example shown in FIG. 4.

In particular, as illustrated by FIG. 4, it is assumed that: 1) the tight link 420 (i.e., the path segment or router that allows the smallest maximum bandwidth from the sender to the receiver) has a bandwidth capacity of Cₜ bps; and that 2) there is some cross traffic 410 from other points of the network having a rate of X bps. Then, assuming that the incoming rate of probing traffic 400 to the tight link 420 from the sender is exactly the probing rate Rᵢ, the incoming gap between probing packets is given by gᵢ=L/Rᵢ, where L is the packet length in bits. It is further assumed all UDP probing packets to have the same length. As such, the rate of the aggregate or combined traffic 430 arriving at the tight link is Rᵢ+X, which is assumed to exceed the tight link capacity of Cₜ. If it is assumed that the capacity of the tight link 420 is shared among competing traffic (i.e., cross traffic) in proportion to the incoming rate of the competing traffic, then the outgoing rate of the probing traffic, denoted as Rₒ, is given by Equation (2), where:

$${R}_{o} = \frac{L}{{g}_{o}} = \frac{{R}_{i}}{{R}_{i} + X} \qquad Equation ( 2 )$$

where gₒ is the gap interval at which the probing packets leave the tight link. Assuming gₒ is the same as the receiving gap measured at the receiver, then the available bandwidth A, is simply Cₜ−X, which can be derived as illustrated by Equation (3), where:

$$A = {C}_{t} - \frac{{C}_{t} {g}_{o} - {R}_{i} {g}_{i}}{{g}_{i}} \qquad Equation ( 3 )$$

PGM needs the capacity of the tight link, Cₜ, which can be obtained by methods such as packet pair probing. When there is more than one link between the sender and the receiver, conventional PGM based approaches may significantly underestimate the available bandwidth in the case where the tight link does not correspond to the narrow link, which leads to a wrong estimate of the Cₜ. Further, it should be noted that in multi-link scenarios (such as multi-hop paths like the Internet), PGM based approaches can only underestimate the available bandwidth, but not overestimate it.

Clearly, one advantage of conventional PGM based schemes is that they have the potential to generate an estimate of the available bandwidth in one probe, rather than several probes, as with conventional PRM based schemes. However, these types of PGM based schemes require a number of significant assumptions and knowledge that are not easy to verify or obtain in real-world conditions. For example, conventional PGM based estimation approaches require: 1) knowledge (or at least a guess) of the actual capacity of the tight link; 2) that the probing rate must be higher but not much higher than the available bandwidth; 3) that the incoming rate to the tight link is the same as the probing rate; and 4) that the outgoing gap (or delay) of the probing packets from the tight link can be accurately measured.

In actual real-world conditions, such information is generally not available. As such, PGM based approaches generally provide sending rates that are below the actually available bandwidth, resulting in a degradation of the communications quality that relative to more accurate available bandwidth estimations.

### 2.3 Exemplary Bandwidth Utilization Scenarios

There are many different communications scenarios in which the communications rate controller is capable of providing dynamic control of the communications sending rate in terms of available bandwidth estimations. For purposes of explanation, several such scenarios are summarized below in Table 1. However, it should be understood that the following scenarios are not intended to limit the application or use of the communications rate controller, and that the other communication scenarios are enabled in view of the detailed description of the communications rate controller provided herein.

In general, enabling real-world RTC scenarios (such as those summarized above in Table 1) involve determining: 1) where the communications bottleneck is (i.e., where the tight link is along the communications path); and 2) an appropriate time scale for performing bandwidth estimations.

TABLE 1
Example RTC Scenarios

1) Broadband Utilization Scenario: Endpoint connects from typical consumer
broadband link for typical RTC scenarios (i.e., point-to-point calls and conferencing
including audio and/or video streams). No additional endpoint traffic.
2) Broadband Adaptation Scenario: Endpoint connects from typical consumer
broadband link for typical RTC scenarios. Fluctuations in bandwidth due to other
traffic (e.g., sending/receiving files or e-mail).
3) Corpnet Utilization Scenario: Endpoint connects from dedicated high speed
corporate link (e.g., Gigabit, 100 MBit, 10 MBit, etc). No additional endpoint traffic.
4) Corpnet Adaptation Scenario: Endpoint connects from a dedicated high-speed
corporate link for typical RTC scenarios. Fluctuations in bandwidth due to other
traffic (e.g., sending/receiving large files or e-mail), or congestion in the local
network.
5) Remote Office Utilization Scenario: Endpoint connects from a shared remote
office link for typical RTC scenarios. No additional endpoint traffic.
6) Remote Office Adaptation Scenario: Endpoint connects from a shared remote
office link for typical RTC scenarios. Fluctuations in bandwidth due to other traffic
(e.g., sending/receiving large files or e-mail), or congestion in the local network.
7) Dial-Up Voice Utilization Scenario: Endpoint connects from typical dial-up link
for audio-only RTC scenarios including point-to-point calls and conferencing. No
additional endpoint traffic.
8) Dial-Up Voice Adaptation Scenario: Endpoint connects from typical dial-up link
for audio-only RTC scenarios including point-to-point calls and conferencing.
Fluctuations in bandwidth due to other traffic (e.g., sending/receiving files or e-mail),
or congestion in the local network.
9) Mesh Conference Utilization Scenario: Endpoint connects to RTC conference
(audio and/or video) using a mesh network where each user has an independent
stream to the other conference members. No additional endpoint traffic.
10) Mesh Conference Adaptation Scenario: Endpoint connects to RTC conference
(audio and/or video) using a mesh network where each user has an independent
stream to the other conference members. Fluctuations in bandwidth due to other
traffic (e.g., sending/receiving files or e-mail), or congestion in the local network.

With respect to evaluating network bottlenecks, there are several issues to consider. For example, whether each user endpoint is connected to the Internet (or other network) via copper or fiber DSL, cable modem, 3G wireless, or other similar rate connections provided by a typical Internet service provider (ISP), network bottlenecks are typically located in the first hop. Limiting factors here generally include considerations such as a maximum upload capacity controlled by the ISP. On the other hand, where each user endpoint is connected to the Internet via Gigabit or 100 Mbit links, or other high speed connections, bottlenecks may be anywhere along the path between the endpoints. Prior knowledge of the bottleneck hop position is useful in estimating available bandwidth.

With respect to the time scale on which the available bandwidth estimations should be carried out, there are also several issues to consider. For example, conventional bandwidth estimation schemes generally rely on the assumption that network traffic along the end-to-end path can be approximated using a fluid flow model. These conventional fluid flow models generally ignore packet level dynamics caused by router/switch serving policies, glitches in packet processing time, and other variations in time caused by link layer retransmissions and noise in processing packets. Consequently, conventional fluid models generally only provide a good approximation of available bandwidth when the time scale of the approximation is substantially larger than the packet level dynamics.

Therefore, in order to generate a robust estimation of available bandwidth, it is crucial to perform the bandwidth estimation on a time scale that is much larger than that of packet level dynamics. For instance, in a typical ISP based cable modem service, the switch applies a fair serving policy that serves customers in a round-robin manner. Consequently, packets going from one customer's home to the Internet can get queued at the switch and sent out in a burst when the customer's turn comes. This type of local queuing generally causes a 5-10 ms burstiness in packet dynamics. As such, trying to measure available bandwidth within a 10 ms time scale will generate highly fluctuating estimates.

In view of the above described RTC scenario considerations, several observations are made in implementing the various embodiments of the communications rate controller. In particular, the observations described in the following paragraphs are considered for implementing various embodiments of the communications rate controller for estimating available bandwidth, as described in further detail in Section 2.4.

First, it is observed that for many RTC scenarios, the bottlenecks are at the first k hops away from the sending endpoint, where k is generally a relatively small. For example, in the case where endpoints are connecting to a RTC using a typical ISP based broadband connection (see Scenario 1 in Table 1, for example), k is likely to take a value of approximately 1 or 2.

Second, it is observed that the time scale on which the available bandwidth estimation is carried out, in all RTC scenarios, is on the order of some small number of seconds in order to maximize user experience. Compared to time scale of the packet dynamics, typically on the order of a few ms to tens of ms, the requirement to perform fluid approximation on the traffic is satisfied for all targeting scenarios.

Third, it is observed that most RTC scenarios, with the exception of high-speed corporate links, such as those described in Scenarios 3 and 4 in Table 1, have relatively low bandwidth access links, representing typical cases of video conferencing between two or many users in which users' media experience can be improved significantly if the available bandwidth is known.

### 2.4 Available Bandwidth Estimations for RTC

For typical RTC scenarios, such as those summarized above in Table 1, the communications rate controller enables various real-time bandwidth estimation techniques. Given the typical RTC scenarios and observations described in Section 2.3, the communications rate controller acts to maximize utilization of the available bandwidth in any RTC scenario to improve communications quality. Further, in various embodiments, where video is used in a particular RTC session, video quality is maximized under the constraints that audio conferencing quality is given priority by limiting any additional end-to-end delay caused by increasing bandwidth available for video components of the RTC session.

In general, the communications rate controller begins operation by sending probing traffic with an exponentially increasing rate, and looks at the transition where queuing delay is first observed. Note that the initial rate at which probing traffic is first sent can be determined using any desired method, such as, for example, conventional bandwidth estimates based on packet pair measurements, packet train measurements, or any other desired method. As soon as queuing delay is observed, the current probing rate must be higher than the available bandwidth of the path between the endpoints. Therefore the communications rate controller uses a technique drawn from PGM based approaches and immediately estimates the available bandwidth using Equation (3).

For example, in one embodiment, the communications rate controller mingles Internet Control Message Protocol (ICMP) packets with existing payload packets (audio and/or video packets of the RTC session) to probe the tight link which is assumed to be k hops away from the sender's endpoint. When k takes sufficiently large value, the tight link can essentially be anywhere along the end-to-end path. As is known to those skilled in the art, ICMP is one of the core protocols used in Internet communications. ICMP is typically used by a networked computers' operating system to send error messages indicating, for example, that a requested service is not available or that a host or router could not be reached. However, in the present case, ICMP packets are adapted for use as “probe packets” to determine delay characteristics of the network.

In another embodiment, the communications rate controller controls the sending rate of video packets, and uses some or all of those packets as the probing traffic (i.e., the “probing packets”) to determine the available bandwidth of the path on the fly. Since the communications rate controller delivers video packets at the probing rate when it estimates the available bandwidth, it can also be considered as a rate control technique for video traffic. However, in contrast to conventional video rate control schemes which attempt to get a “fair share” of total network bandwidth for video traffic, the communications rate controller specifically attempts to utilize the available bandwidth of the path.

In another embodiment, the communication rate controller mingles parity packets in the probing traffic, the parity packets being any redundant information usable to recover lost data packets such as audio and video data packets. More specifically, parity packets are useful for probing because the probe can cause packet loss in some cases, which the parity packets can protect against. Using parity packets as part of the probe packets allows the audio and video encoding rates to change more slowly than the probing rate. Using dummy probe packets (without parity) would also allow the audio and video encoding rates to change more slowly than the probing rate, but dummy probe packets don't protect against loss of audio and video packets. Consequently, including parity packets in the probe traffic can produce better loss characteristics than simply using dummy probe packets. Note that the general concept of parity packets in known to those skilled in the art for protecting against data loss, though such use is not in the context of the communication rate controller described herein.

### 2.4.1 Parameter Definitions for Available Bandwidth Estimations

The following discussion refers to parameters that are used for implementing various embodiments of the communications rate controller. In particular, Table 2 lists variables and parameters that are used in implementing various tested embodiments of the communications rate controller. Note that the exemplary parameter values provided in Table 2 are only intended to illustrate a tested embodiment of the communications rate controller, and are not intended to limit the range of any listed parameter. In particular, the values of the parameters shown in Table 2 may be set to any desired value, depending upon the intended application or use of the communications rate controller.

TABLE 2
Variable Definitions

| Param- | | Exemplary |
|---|---|---|
| eter | Description | Values |
| A | Available Bandwidth | |
| μ | Damping factor for estimating the average | 0.25 |
| | queuing delay | |
| d̅_̅{̅q̅}̅ | Average queuing delay | |
| γ | Allowable Delay threshold. This parameter | 25 ms |
| | controls a sensitivity to transient decreases in A | |
| Rᵢ | Communications sending rate | |
| α | Parameter for determining how aggressively Rᵢ | 0.25 |
| | should follow an increase in the available | |
| | bandwidth, A | |
| β | Parameter for determining how aggressively Rᵢ | 0.75 |
| | should follow a decrease in the available | |
| | bandwidth, A | |
| τ | Parameter for setting a time sensitivity to transient | 2 seconds |
| | increases in the available bandwidth, A | |
| N | Parameter for setting a sensitivity to transient | 60 packets |
| | increases in the available bandwidth, A, with | |
| | respect to a number consecutive audio packets | |

### 2.4.2 Available Bandwidth Estimation Embodiments

In general, in a RTC session between a sender and a receiver, encoded audio packets (compressed using conventional lossy or lossless compression techniques, if desired), are transmitted from the sending endpoint to the receiving endpoint across the network at some desired sending rate. In a tested embodiment, audio packets had a size on the order of about 200 bytes, and were transmitted from the sending endpoint on the order of about every 20 ms. Video packets (if video is included in the RTC session) are then encoded (and compressed using conventional lossy or lossless compression techniques, if desired) into a video stream at a sending rate that is automatically set by communications rate controller based on estimated available bandwidth. Separate probe packets may also be transmitted to the receiving endpoint in the case that video packets are not used for this purpose.

End-to-end statistics regarding packet delivery (audio, video and probe packets) are then collected by the sending endpoint on an ongoing basis so that the communications rate controller can continue to estimate available bandwidth on an ongoing basis during the RTC session. End-to-end statistics collected include relative one way delay, jitter of audio packets, and video/probe packets sending and receiving gaps, with time stamps of TCP acknowledgement packets (or similar acknowledgment packets) returned from the receiving endpoint, or from routers along the network path, being used to determine these statistics.

Then, given the one way delay samples and the receiving gaps of the audio packets, the communications rate controller estimates the queuing delay based on the one way delay samples. The communications rate controller then increases the video sending rate Rᵢ proportionally if the estimated queuing delay is less than a threshold, or decreases Rᵢ to the available bandwidth computed by Equation (3) otherwise.

More specifically, the communications rate controller uses the current minimum one way delay as the current estimate of the one way propagation delay dₚ. The queuing delay experienced by an audio packet, denoted as d_{q}, is the difference between its one way delay d and dₚ, shown in Equation (1). Given this information, the communications rate controller dynamically updates an average queuing delay d̅_̅{̅q̅}̅ as illustrated by Equation (4), where:

d̅_̅{̅q̅}̅=μd_{q}+(1−μ) d̅_̅{̅q̅}̅ Equation (4)

where μ is a damping factor between 0 and 1. As shown in Table 2, in a tested embodiment this damping factor, μ, was set to a value of 0.25.

Next, the communications rate controller compares the average queuing delay, d̅_̅{̅q̅}̅, to the aforementioned delay threshold, γ, to determine whether to increase, decrease, or keep the current sending rate of video packets. Hence, γ controls how the sensitivity of communications rate controller to transient decreases in A. In a tested embodiment, γ was set to be equal to the queuing delay that audio traffic can tolerated before the audio conferencing experience starts to degrade (relative to criteria such as packet loss and jitter). As shown in Table 2, in a tested embodiment, the delay threshold, γ, was set to a value of 25 ms. However, it should be noted that this delay threshold will typically be dependent upon the particular audio codec being used to encode the audio component of the RTC session.

As noted above, if the average queuing delay exceeds the delay threshold, then the current sending rate must be exceeding the available bandwidth. In other words, if d̅_̅{̅q̅}̅>γ, then the current sending rate, Rᵢ, exceeds the available bandwidth of the path A. In this case, an estimate on the available bandwidth of the path can be computed by Equation (3). Next, following this computation of the available bandwidth, the sending rate, Rᵢ, is updated as illustrated by Equation (5), where:

$${R}_{i} = {C}_{t} - \frac{{C}_{t} \overline{{g}_{o}} - {R}_{i} {\overline{g}}_{ι}}{{\overline{g}}_{ι}} \qquad Equation ( 5 )$$

Where g̅ᵢ is the average sending gap of the video packets (or other probe packets) at the sender, and is merely L/Rᵢ. Further, g̅ₒ̅ is the average receiving gap of the video packets (or other probe packets) that are sent at rate Rᵢ. It is known that the receiving gaps are subjected to a variety of noise in the network and are not easy to measure accurately. This type of noise generally includes, but is not limited to, burstiness of network cross traffic, router scheduling policies, and conventional “leaky bucket” mechanisms employed by various types of network infrastructure elements such as cable modems. Note that the term “leaky bucket” generally refers to algorithms like the conventional general cell rate algorithm (GCRA) in an asynchronous transfer mode (ATM) network that is used for conformance checking of cell flows from a user or a network. A “hole” in the leaky bucket represents a sustained rate at which cells can be accommodated, and the bucket depth represents a tolerance for cell bursts over a period of time.

In any case, given noise in the network, it is possible that the measured g̅ₒ̅ is smaller than g̅ᵢ in real world scenarios, even if this is not possible in an ideal noise free case. Therefore, assuming noise, the available bandwidth cannot be accurately estimated by Equation (3). However, since Rᵢ>A, the sending rate, Rᵢ must still be decreased. Consequently, in this case, the communications rate controller performs a multiplicative decrease on Rᵢ as follows:

Rᵢ=γRᵢ Equation (6)

where β is the multiplicative factor between 0 and 1 controlling how fast Rᵢ is decreased, or in other words, how responsive Rᵢ should be in following a decrease in the available bandwidth, A. It should be noted that the decrease is exponentially fast. As shown in Table 2, in a tested embodiment this factor, β, was set to a value of 0.75.

The above described concepts regarding adaptation of the sending rate, Rᵢ, can be summarized as follows: As soon as d̅_̅{̅q̅}̅>γ is observed, Rᵢ is immediately decreased according to the rule illustrated by Equation 7, where:

$${R}_{i} = \{ \begin{matrix}β {R}_{i} , & if \overline{{g}_{o}} < {\overline{g}}_{ι} \\ {C}_{t} - \frac{{C}_{t} \overline{{g}_{o}} - {R}_{i} {\overline{g}}_{ι}}{{\overline{g}}_{ι}} , & otherwise\end{matrix} \qquad Equation ( 7 )$$

Therefore, as soon as Rᵢ>A is observed, either Rᵢ is updated to be an estimate of A directly, or Rᵢ is decreased exponentially. As such, the communications rate controller is very responsive in decreasing Rᵢ, leading to a prompt decrease on d̅_̅{̅q̅}̅ that generally serves to protect audio quality in the RTC session as quickly as possible following any decrease in the available bandwidth.

If on the other hand d̅_̅{̅q̅}̅<γ lasts for sufficiently long time, it is reasonable to assume that Rᵢ<A. In this case, the communications rate controller acts to increase Rᵢ when possible (or if necessary given the current sending rate). Specifically, given that τ and N are preset parameters used to determine how frequently Rᵢ should be increased, if d̅_̅{̅q̅}̅<γ lasts for τ seconds (i.e., the interval to transmit N consecutive audio packets at current rate Rᵢ) then Rᵢ is increased proportionally as illustrated by Equation (8), where:

Rᵢ=(1+α)Rᵢ Equation (8)

where the parameter α takes value between 0 and 1. As such, the parameter a controls how fast Rᵢ should increase, or equivalently, how aggressive Rᵢ should pursue an increase of the available bandwidth, A. Clearly, large τ and N makes the communications rate controller more robust to transient increases in the available bandwidth, A, while making the communications rate controller less aggressive in pursuing increases in A. As shown in Table 2, in a tested embodiment τ was set to be 2 seconds, N was set at a value of 60 packets, and a was set at a value of 0.25. In summary, the communications rate controller proportionally increases Rᵢ if there is no queuing delay being observed for a sufficiently long time. It decreases Rᵢ to the estimated available bandwidth computed by Equation (3) if the receiving gap measurement is meaningful, and exponentially decreases Rᵢ otherwise.

In summary, the communications rate controller proportionally increases Rᵢ if there is no queuing delay is observed for a sufficiently long time. Conversely, the communications rate controller decreases Rᵢ to the estimated available bandwidth computed by Equation (3) if the receiving gap measurement is meaningful, and exponentially decreases Rᵢ otherwise.

### 2.5 Operational Summary of the Communications Rate Controller

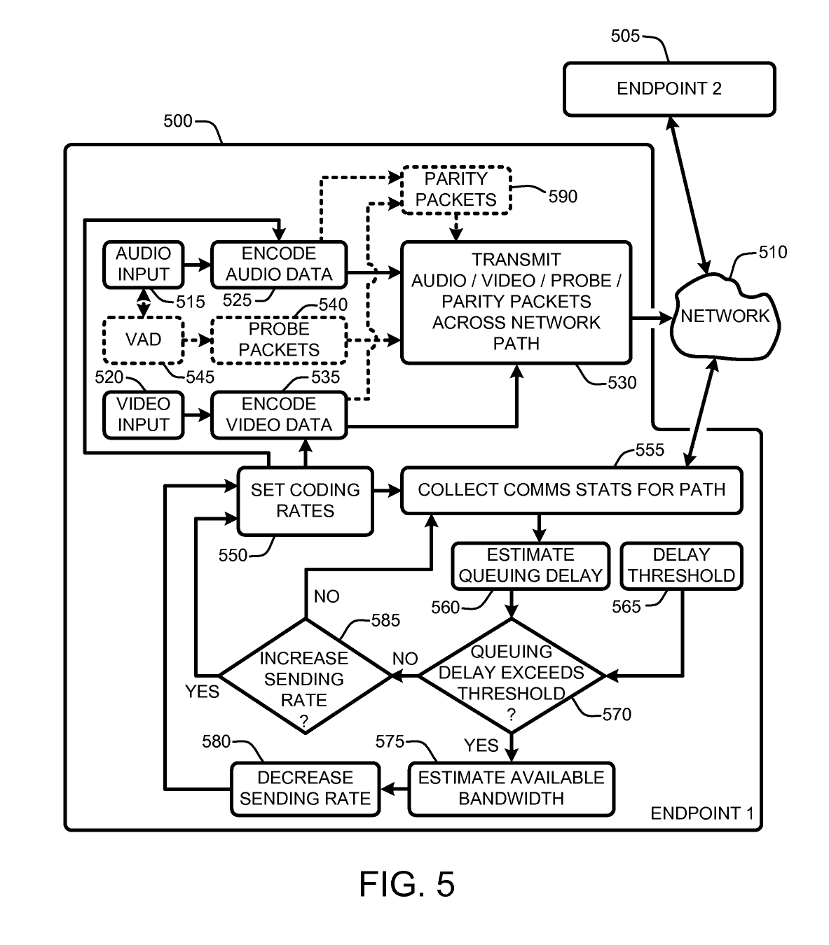

The processes described above with respect to FIG. 2 and in further view of the detailed description provided above in Sections 1 and 2 are illustrated by the general operational flow diagram of FIG. 5. In particular, FIG. 5 provides an exemplary operational flow diagram which illustrates operation of several embodiments of the communications rate controller. Note that FIG. 5 is not intended to be an exhaustive representation of all of the various embodiments of the communications rate controller described herein, and that the embodiments represented in FIG. 5 are provided only for purposes of explanation.

Further, it should be noted that any boxes and interconnections between boxes that are represented by broken or dashed lines in FIG. 5 represent optional or alternate embodiments of the communications rate controller described herein, and that any or all of these optional or alternate embodiments, as described below, may be used in combination with other alternate embodiments that are described throughout this document.

In addition, FIG. 5 shows a first endpoint 500 in communication with a second endpoint 505 across a network 510. However, while not illustrated in FIG. 5 for purposes of clarity, it is intended that in this example, each of the two endpoints, 500 and 505, include the same functionality with respect to the communications rate controller illustrated with respect to the first endpoint 500. Note however, that the second endpoint 505 is not required to use the same rate control techniques as the first endpoint 500 since the communications rate controller controls the sending rate from the first endpoint to the second endpoint independently from any return sending rate from the second endpoint to the first endpoint.

In general, as illustrated by FIG. 5, the communications rate controller begins operation in the first endpoint 500 (i.e., the sending endpoint in this example) by receiving an audio input 515 of a communications session. In addition, assuming that the communications session also includes a video component, the communications rate controller will also receive a video input 520 of the communications session.

The communications rate controller encodes 525 the audio input 515 using any desired conventional audio codec, including layered or scalable codecs having base and enhancement layers, as noted above. Similarly, assuming that there is a video component to the current communications session, the communications rate controller encodes 535 the video data 520 using any desired conventional codec, again including layered or scalable codecs if desired. Priority is given to encoding 525 the audio input 515 in the communications session, given available bandwidth, since it is assumed that the ability to hear the other party takes precedence over the ability to clearly see the other party. However, if desired, priority may instead be given to providing a higher bandwidth to the video stream of the communications session.

Encoding rates for the audio input 515, the video input 525, and parity packets 590 (if used) are dynamically set 550 on an ongoing basis during the communications session in order to adapt to changing network 510 conditions as summarized below, and as specifically described above in Section 2.4. Once encoded, the audio and video streams are transmitted 530 across the network 510 from the first endpoint 500 to the second endpoint 505. In addition, in the case that separate probe packets 540 are used, the probe packets are also transmitted 530 across the network 510 from the first endpoint 500 to the second endpoint 505.

As noted above, in various embodiments, probing traffic can include either the data packets of the communications stream itself (i.e., the encoded audio and/or video packets), or it can include parity packets used to protect the audio and video data packets from loss, or it can include packets used solely for probing the network (examples include the aforementioned use of ICMP packets for use as probe packets 540).

Further, also as noted above, in various embodiments, the rate of probing traffic may be increased without compromising the quality of the communications stream. For example, as noted above, in one embodiment, the communications rate controller uses conventional voice activity detection (VAD) 545 to identify periods of audio silence (non-speech segments) in the audio stream. Then, when the VAD 545 identifies non-speech segments, the communications rate controller automatically increases the rate at which probe packets 540 are transmitted 530 across the network 510 while proportionally decreasing the rate at which non-speech audio packets are transmitted. As soon as the VAD 545 identifies speech presence in the audio input 510, the rate of probing packets 540 is automatically decreased, while simultaneously restoring the audio rate so as to preserve the quality of the audio signal whenever it includes speech segments.

As described in Section 2.3 and 2.4, the communications rate controller uses the probing traffic to collect communications statistics 555 for the communications path between the first endpoint 500 and the second endpoint 505. As noted above, these communications statistics include statistics such as relative one way delay, jitter, video/probe packets sending and receiving gaps, etc.

More specifically, in various embodiments, the communications rate controller receive statistics such as the one way delay samples and the receiving gaps of the audio, video, parity, and/or probe packets that are returned from the network 510. The communications rate controller then estimates the queuing delay 560 from this statistical information.

Next, if the estimated queuing delay 560 exceeds 570 the preset delay threshold 565, then the communications rate controller estimates 575 the available bandwidth of the path as described in Section 2.4. As soon as the available bandwidth is estimated 575, the communications rate controller decreases 580 the sending rate. The sending rate is decreased 580 to at most the estimated available bandwidth 575 since the fact that the queuing delay exceeds 570 the preset delay threshold 565 means that the current rate at which audio and video packets are being transmitted 530 across the network 510 exceeds the available bandwidth by an amount sufficient to cause in increase in the queuing delay at some point along the network path. The decreased sending rate is then used to set current coding rates 550 for audio, video, and parity coding (525, 535, and 590, respectively) relative to the estimated available bandwidth 575.

On the other hand, if the estimated queuing delay 560 does not exceed 570 the preset delay threshold 565, then the communications rate controller decides whether to increase 585 the sending rate. As discussed in Section 2.4, several factors may be considered when determining whether to increase 585 the sending rate. Among these factors are parameters such as the amount of time for which the estimated queuing delay has not exceeded 570 the delay threshold 565. Further, assuming that the sending rate can be increased 585 based on these parameters, it will only be increased if necessary, given the current sending rate. For example, assuming that that the first endpoint is already sending the communications stream at some maximum desired rate to achieve a desired quality (or at a hardware limited rate), then there is no need to further increase the sending rate. Otherwise, the sending rate will always be increased 585 when possible.

In either case, whether or not the sending rate is increased 585, or decreased 580, the communications rate controller continues to periodically collect communications statistics 555 on an ongoing base during the communications session. This ongoing collection of statistics 555 is then used to periodically estimate the queuing delay 560, as described above. The new estimates of queuing delay 560 are then used for making new decisions regarding wither to increase 585 or decrease 580 the sending rate, with those decisions then being used to set the coding rates 550, as described above.

The dynamic adaptation of coding rates (550) and sending rates (580 or 585) described above then continues throughout the communications session in view of the ongoing estimates available bandwidth 575 relative to the ongoing collection of communications statistics 555. The result of this dynamic process is the communications rate controller dynamically performs in-session bandwidth estimation with application aware rate control for dynamically controlling sending rates of audio, video, and parity streams from the first endpoint 500 to the second endpoint 505 during the communications session. Similarly, assuming the second endpoint 505 is sending a communications stream to the first endpoint 500, the second endpoint can separately perform the same operations described above to dynamically control the sending rates of the communications stream from the second endpoint to the first endpoint.

Further, in the case where there are multiple participants in a mesh-type communications session, it is assumed that each endpoint has a separate stream to each other participant. In this case, each of the streams is controlled separately by performing the same dynamic rate control operations described above with respect to the first endpoint 500 sending a communications stream to the second endpoint 505.

### 3.0 Additional Embodiments and Considerations

As described above in Section 2.4, one way delay samples drawn from the RTC communications stream were used to estimate the queuing delay. However, also as noted above, it is possible to use other probe packets, such as ICMP packets, to sample the round trip delays between the sender and the bottleneck (tight link) router. In most cases (especially with typical commercial ISP's providing residential or commercial broadband cable modems or DSL services), the bottleneck is at the first hop from the sender. In this case, ICMP packets are used to estimate the queuing delay to the bottleneck based on these samples. ICMP packets can also be applied to measure the gaps of the video packets coming out of the tight link.

As noted in Section 2.2, several elements need to be made verified in order for Equation (3) to generate a correct estimate for the available bandwidth across the path from the sender to the receiver. In particular, conventional PGM based estimation approaches require: 1) knowledge (or at least a guess) of the actual capacity of the tight link; 2) that the probing rate must be higher but not much higher than the available bandwidth; 3) that the incoming rate to the tight link is the same as the probing rate; and 4) that the outgoing gap (or delay) of the probing packets from the tight link can be accurately measured. However, it has been observed that each of the following four assumptions are valid in most of the RTC scenarios listed in Table 1. As such, the communications rate controller is capable of providing available bandwidth estimations that are more accurate than conventional PGM based schemes.

First, in almost all listed scenarios, the first hop is the tight link. In this case, the capacity of the tight link can be measured using packet-pair based techniques. It should be noted that in some scenarios, such as conferencing between two cable modem based endpoints, leaky bucket mechanisms might cause packet-pair based techniques to overestimate available bandwidth. In this case, slightly modified packet-pair techniques can still generate the correct estimate for available bandwidth. Therefore, it is reasonable to assume that the capacity of the tight link is known.

Second, the communications rate controller only applies Equation (3) upon observing queuing delay in excess of the delay threshold. As noted above, this case indicates that the current sending rate must be in excess of the available bandwidth of the path.

Third, in most of the scenarios illustrated in Table 1, the first link is the tight link. Therefore, the maximum allowable sending rate of that first link of is merely the probing rate.

The fourth assumption, that the outgoing gap (or delay) of the probing packets from the tight link can be accurately measured, also holds in most practical RTC scenarios. In fact, the only known scenario, in which this last assumption does not hold, requires both that Rᵢ [symbol] A, and that there are several links along the network path having similar available bandwidths. These requirements are not likely to occur in most of the scenarios summarized in Table 1.

### 4.0 Exemplary Operating Environments

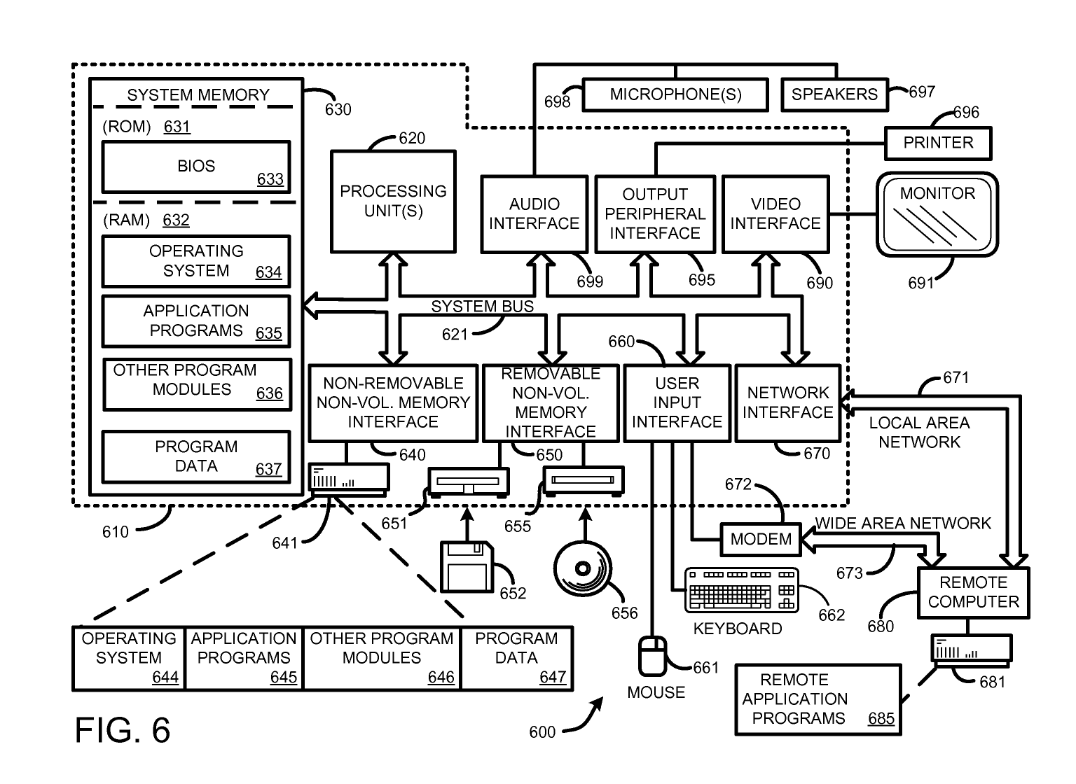

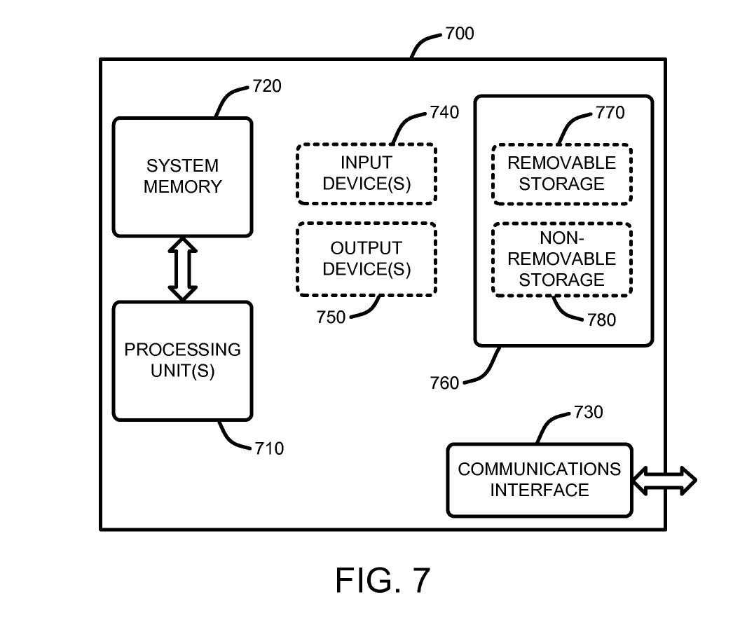

FIG. 6 and FIG. 7 illustrate two examples of suitable computing environments on which various embodiments and elements of a communications rate controller, as described herein, may be implemented.

For example, FIG. 6 illustrates an example of a suitable computing system environment 600 on which the invention may be implemented. The computing system environment 600 is only one example of a suitable computing environment and is not intended to suggest any limitation as to the scope of use or functionality of the invention. Neither should the computing environment 600 be interpreted as having any dependency or requirement relating to any one or any combination of the components illustrated in the exemplary operating environment 600.

The invention is operational with numerous other general purpose or special purpose computing system environments or configurations. Examples of well known computing systems, environments, and/or configurations that may be suitable for use with the invention include, but are not limited to, personal computers, server computers, hand-held, laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer in combination with hardware modules, including components of a microphone array 698. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices. With reference to FIG. 6, an exemplary system for implementing the invention includes a general-purpose computing device in the form of a computer 610.

Components of computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 610 typically includes a variety of computer readable media. Computer readable media can be any available media that can be accessed by computer 610 and includes both volatile and nonvolatile media, removable and non-removable media. By way of example, and not limitation, computer readable media may comprise computer storage media such as volatile and nonvolatile removable and non-removable media implemented in any method or technology for storage of information such as computer readable instructions, data structures, program modules, or other data.

For example, computer storage media includes, but is not limited to, storage devices such as RAM, ROM, PROM, EPROM, EEPROM, flash memory, or other memory technology; CD-ROM, digital versatile disks (DVD), or other optical disk storage; magnetic cassettes, magnetic tape, magnetic disk storage, or other magnetic storage devices; or any other medium which can be used to store the desired information and which can be accessed by computer 610.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636, and program data 637.

The computer 610 may also include other removable/non-removable, volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media discussed above and illustrated in FIG. 6, provide storage of computer readable instructions, data structures, program modules and other data for the computer 610. In FIG. 6, for example, hard disk drive 641 is illustrated as storing operating system 644, application programs 645, other program modules 646, and program data 647. Note that these components can either be the same as or different from operating system 634, application programs 635, other program modules 636, and program data 637. Operating system 644, application programs 645, other program modules 646, and program data 647 are given different numbers here to illustrate that, at a minimum, they are different copies. A user may enter commands and information into the computer 610 through input devices such as a keyboard 662 and pointing device 661, commonly referred to as a mouse, trackball, or touch pad.

Other input devices (not shown) may include a joystick, game pad, satellite dish, scanner, radio receiver, and a television or broadcast video receiver, or the like. These and other input devices are often connected to the processing unit 620 through a wired or wireless user input interface 660 that is coupled to the system bus 621, but may be connected by other conventional interface and bus structures, such as, for example, a parallel port, a game port, a universal serial bus (USB), an IEEE 1394 interface, a Bluetooth™ wireless interface, an IEEE 802.11 wireless interface, etc. Further, the computer 610 may also include a speech or audio input device, such as a microphone or a microphone array 698, as well as a loudspeaker 697 or other sound output device connected via an audio interface 699, again including conventional wired or wireless interfaces, such as, for example, parallel, serial, USB, IEEE 1394, Bluetooth™, etc.

A monitor 691 or other type of display device is also connected to the system bus 621 via an interface, such as a video interface 690. In addition to the monitor, computers may also include other peripheral output devices such as a printer 696, which may be connected through an output peripheral interface 695.

The computer 610 may operate in a networked environment using logical connections to one or more remote computers, such as a remote computer 680. The remote computer 680 may be a personal computer, a server, a router, a network PC, a peer device, or other common network node, and typically includes many or all of the elements described above relative to the computer 610, although only a memory storage device 681 has been illustrated in FIG. 6. The logical connections depicted in FIG. 6 include a local area network (LAN) 671 and a wide area network (WAN) 673, but may also include other networks. Such networking environments are commonplace in offices, enterprise-wide computer networks, intranets, and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660, or other appropriate mechanism. In a networked environment, program modules depicted relative to the computer 610, or portions thereof, may be stored in the remote memory storage device. By way of example, and not limitation, FIG. 6 illustrates remote application programs 685 as residing on memory device 681. It will be appreciated that the network connections shown are exemplary and other means of establishing a communications link between the computers may be used.

With respect to FIG. 5, this figure shows a general system diagram showing a simplified computing device. Such computing devices can be typically be found in devices having at least some minimum computational capability in combination with a communications interface, including, for example, cell phones PDA's, dedicated media players (audio and/or video), etc. It should be noted that any boxes that are represented by broken or dashed lines in FIG. 5 represent alternate embodiments of the simplified computing device, and that any or all of these alternate embodiments, as described below, may be used in combination with other alternate embodiments that are described throughout this document.

At a minimum, to allow a device to implement the communications rate controller, the device must have some minimum computational capability, and some memory or storage capability. In particular, as illustrated by FIG. 7, the computational capability is generally illustrated by processing unit(s) 710 (roughly analogous to processing units 620 described above with respect to FIG. 6). Note that in contrast to the processing unit(s) 620 of the general computing device of FIG. 6, the processing unit(s) 710 illustrated in FIG. 7 may be specialized (and inexpensive) microprocessors, such as a DSP, a VLIW, or other micro-controller rather than the general-purpose processor unit of a PC-type computer or the like, as described above.

In addition, the simplified computing device of FIG. 7 may also include other components, such as, for example one or more input devices 740 (analogous to the input devices described with respect to FIG. 6). The simplified computing device of FIG. 7 may also include other optional components, such as, for example one or more output devices 750 (analogous to the output devices described with respect to FIG. 6). Finally, the simplified computing device of FIG. 7 also includes storage 760 that is either removable 770 and/or non-removable 780 (analogous to the storage devices described above with respect to FIG. 6).

The foregoing description of the communications rate controller has been presented for the purposes of illustration and description. It is not intended to be exhaustive or to limit the invention to the precise form disclosed. Many modifications and variations are possible in light of the above teaching. Further, it should be noted that any or all of the aforementioned alternate embodiments may be used in any combination desired to form additional hybrid embodiments of the communications rate controller. It is intended that the scope of the invention be limited not by this detailed description, but rather by the claims appended hereto.

What is claimed is:

1. A method for performing real-time estimation of available bandwidth between endpoints in a network for dynamically controlling communication data rates, comprising using a computing device for:
establishing a communications session between a first network endpoint and a second network endpoint across a network path including one or more network nodes between the first and second network endpoints;
wherein the communications session includes an ongoing transmission of encoded communications data packets from the first network endpoint to the second network endpoint at a current sending rate;
periodically collecting network statistical information during the communications session;
periodically computing a current packet queuing delay for at least some of the communications data packets transmitted from the first network endpoint to the second network endpoint;
periodically performing a real-time estimate of a current available bandwidth from current network statistical information; and
periodically adjusting the current sending rate to be as close as possible to the current available bandwidth, with the current available bandwidth representing an upper maximum limit on the current sending rate, based on a computed relationship between the current packet queuing delay and an allowable delay threshold.

2. The method of claim 1 wherein the current sending rate is initially determined by automatically increasing the current sending rate, beginning with a minimum current sending rate, until the current packet queuing delay exceeds the allowable delay threshold at any of the network nodes.

3. The method of claim 1 wherein the current sending rate is automatically decreased as soon as the current packet queuing delay exceeds the allowable delay threshold at any of the network nodes.

4. The method of claim 1 wherein the current sending rate is automatically increased whenever the current packet queuing delay is less than the allowable delay threshold for a predetermined period of time.

5. The method of claim 1 wherein the encoded communications data packets includes an encoded audio stream and an encoded video stream or a parity stream.

6. The method of claim 5 wherein the sending rate is divided between the encoded audio stream and the encoded video stream or the parity stream, and wherein a first portion of the sending rate, used for transmission of the encoded audio stream from the first network endpoint to the second network endpoint, is maintained at a constant rate when decreasing the sending rate.

7. The method of claim 1 wherein the encoded communication data packets are encoded using scalable coding having a base layer and one or more enhancement layers, and wherein one or more of the enhancement layers are added to the communications data packets whenever the sending rate is increased.

8. The method of claim 1 wherein the allowable delay threshold is set to ensure acceptable packet loss and jitter control characteristics of at least a portion of the communications data packets.

9. The method of claim 1 wherein the communications data packets include a series of periodic probing packets that are used to generate the network statistical information during the communications session.

10. A process for dynamically controlling a sending rate of a communications session between endpoints in a network, comprising steps for:
(a) establishing a communications session along a network communications path from a first network endpoint and a second network endpoint, said path including one or more network nodes;
(b) setting an acceptable quality level for the communications session;
(c) beginning with an initial sending rate, increasing a current sending rate of the communications session until a current packet queuing delay at the current sending rate at any of the network nodes exceeds the allowable delay threshold;
(d) gathering current network statistical information;
(e) computing an available bandwidth based on the current network statistical information, said statistical information comprising at least the current packet queuing delay;
(f) using a computed relationship between the current packet queuing delay and the allowable delay threshold for setting a real-time communications rate for sending communications data packets from the first network endpoint to the second network endpoint, and using the computed available bandwidth as an upper limit on the real-time communications rate; and
(g) periodically repeating steps (d) through (f) during the communications session to dynamically adjust the real-time communications rate for maximally utilizing available bandwidth between the first network endpoint and the second network endpoint.

11. The process of claim 10 further comprising steps for decreasing the real-time communications rate as soon as the current packet queuing delay exceeds the allowable delay threshold at any of the network nodes.

12. The process of claim 10 further comprising increasing the real-time communications rate whenever the current packet queuing delay is less than the allowable delay threshold at all of the network nodes for a predetermined period of time.

13. The process of claim 10 further comprising steps for setting the allowable delay threshold to ensure acceptable packet loss and jitter control characteristics of at least a portion of the communications data packets.

14. The process of claim 10 wherein the encoded communications data packets includes an encoded audio stream and an encoded video stream or a parity stream.

15. The process of claim 14 wherein the real-time communications rate is divided between the encoded audio stream and the encoded video stream or the parity stream, and wherein a first portion of the real-time communications rate, used for transmission of the encoded audio stream from the first network endpoint to the second network endpoint, is maintained at a constant rate when decreasing the real-time communications rate.

16. A computer-readable medium having computer executable instructions stored thereon for performing in-session bandwidth estimation and rate control during a communications session between network endpoints, comprising instructions for:
setting an allowable delay threshold in a network path between a first network endpoint and a second network endpoint, said path including one or more network nodes;
beginning with an initial current sending rate, increasing the current sending rate of communications data packets from the first network endpoint to the second network endpoint until a current packet queuing delay at the current sending rate at any of the network nodes exceeds the allowable delay threshold;
periodically recomputing the current packet queuing delay;
periodically computing a current available bandwidth using the current sending rate and the current packet queuing delay in combination with periodically collected network statistical information; and
periodically evaluating the current packet queuing delay and adjusting the current sending rate relative to the current available bandwidth.

17. The computer-readable medium of claim 16 further comprising instructions for decreasing the current sending rate as soon as the current packet queuing delay exceeds the allowable delay threshold at any of the network nodes.

18. The computer-readable medium of claim 16 further comprising instructions for increasing the current sending rate whenever the current packet queuing delay is less than the allowable delay threshold at all of the network nodes for a predetermined period of time.

19. The computer-readable medium of claim 16 further comprising instructions for setting the allowable delay threshold to ensure acceptable packet loss and jitter control characteristics of at least a portion of the communications data packets.

20. The computer-readable medium of claim 16 wherein the communications data packets include an encoded audio stream and an encoded video stream or a parity stream, and further comprising instructions for:
dividing the current sending rate between the encoded audio stream and the encoded video stream or the parity stream; and
wherein a first portion of the real-time communications rate, used for transmission of the encoded audio stream from the first network endpoint to the second network endpoint, is maintained at a constant rate when decreasing the current sending rate.
